(19) United States
(12) Patent Application Publication
(10) Pub. No.: US 2025/0274258 A1
(43) Pub. Date: Aug. 28, 2025

(54) USER-EQUIPMENT-INITIATED DUPLEXING CONFIGURATION

(71) Applicant: QUALCOMM Incorporated, San Diego, CA (US)

(72) Inventors: Qian ZHANG, Basking Ridge, NJ (US); Yan ZHOU, San Diego, CA (US); Jelena DAMNJANOVIC, Del Mar, CA (US)

(21) Appl. No.: 18/586,314

(22) Filed: Feb. 23, 2024

(51) Int. Cl. H04L 5/16; H04L 5/00; H04W 72/0446

(52) U.S. Cl. CPC H04L 5/16; H04L 5/0053; H04W 72/0446

(57) ABSTRACT

Various aspects of the present disclosure generally relate to wireless communication. In some aspects, a user equipment (UE) may transmit, to a network node, signaling to initiate a time window with support for uplink communication in each interval within the time window based on a predicted uplink traffic pattern during the time window. The UE may receive, from the network node, signaling that indicates a duplexing configuration during the time window. The UE may transmit, to the network node, one or more uplink communications during the time window in accordance with the duplexing configuration. Numerous other aspects are described.

### FIELD OF THE DISCLOSURE

Aspects of the present disclosure generally relate to wireless communication and specifically relate to techniques, apparatuses, and methods associated with a user-equipment-initiated duplexing configuration.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a user equipment (UE). The method may include transmitting, to a network node, signaling to initiate a time window with support for uplink communication in each interval within the time window based on a predicted uplink traffic pattern during the time window. The method may include receiving, from the network node, signaling that indicates a duplexing configuration during the time window. The method may include transmitting, to the network node, one or more uplink communications during the time window in accordance with the duplexing configuration.

Some aspects described herein relate to a method of wireless communication performed by a network node. The method may include receiving, from a UE, signaling to initiate a time window with support for uplink communication in each interval within the time window based on a predicted uplink traffic pattern during the time window. The method may include transmitting, to the UE, signaling that indicates a duplexing configuration during the time window. The method may include receiving, from the UE, one or more uplink communications during the time window in accordance with the duplexing configuration.

Some aspects described herein relate to a UE for wireless communication. The UE may include one or more memories and one or more processors coupled to the one or more memories. The one or more processors may be configured to transmit, to a network node, signaling to initiate a time window with support for uplink communication in each interval within the time window based on a predicted uplink traffic pattern during the time window. The one or more processors may be configured to receive, from the network node, signaling that indicates a duplexing configuration during the time window. The one or more processors may be configured to transmit, to the network node, one or more uplink communications during the time window in accordance with the duplexing configuration.

Some aspects described herein relate to a network node for wireless communication. The network node may include one or more memories and one or more processors coupled to the one or more memories. The one or more processors may be configured to receive, from a UE, signaling to initiate a time window with support for uplink communication in each interval within the time window based on a predicted uplink traffic pattern during the time window. The one or more processors may be configured to transmit, to the UE, signaling that indicates a duplexing configuration during the time window. The one or more processors may be configured to receive, from the UE, one or more uplink communications during the time window in accordance with the duplexing configuration.

Some aspects described herein relate to a non-transitory computer-readable medium that stores a set of instructions for wireless communication by a UE. The set of instructions, when executed by one or more processors of the UE, may cause the UE to transmit, to a network node, signaling to initiate a time window with support for uplink communication in each interval within the time window based on a predicted uplink traffic pattern during the time window. The set of instructions, when executed by one or more processors of the UE, may cause the UE to receive, from the network node, signaling that indicates a duplexing configuration during the time window. The set of instructions, when executed by one or more processors of the UE, may cause the UE to transmit, to the network node, one or more uplink communications during the time window in accordance with the duplexing configuration.

Some aspects described herein relate to a non-transitory computer-readable medium that stores a set of instructions for wireless communication by a network node. The set of instructions, when executed by one or more processors of the network node, may cause the network node to receive, from a UE, signaling to initiate a time window with support for uplink communication in each interval within the time window based on a predicted uplink traffic pattern during the time window. The set of instructions, when executed by one or more processors of the network node, may cause the network node to transmit, to the UE, signaling that indicates a duplexing configuration during the time window. The set of instructions, when executed by one or more processors of the network node, may cause the network node to receive, from the UE, one or more uplink communications during the time window in accordance with the duplexing configuration.

Some aspects described herein relate to an apparatus for wireless communication. The apparatus may include means for transmitting, to a network node, signaling to initiate a time window with support for uplink communication in each interval within the time window based on a predicted uplink traffic pattern during the time window. The apparatus may include means for receiving, from the network node, signaling that indicates a duplexing configuration during the time window. The apparatus may include means for transmitting, to the network node, one or more uplink communications during the time window in accordance with the duplexing configuration.

Some aspects described herein relate to an apparatus for wireless communication. The apparatus may include means for receiving, from a UE, signaling to initiate a time window with support for uplink communication in each interval within the time window based on a predicted uplink traffic pattern during the time window. The apparatus may include means for transmitting, to the UE, signaling that indicates a duplexing configuration during the time window. The apparatus may include means for receiving, from the UE, one or more uplink communications during the time window in accordance with the duplexing configuration.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram illustrating an example disaggregated base station architecture in accordance with the present disclosure.

FIG. 4 is a diagram illustrating examples of full-duplex communication in a wireless network, in accordance with the present disclosure.

FIG. 5 is a diagram illustrating examples of full-duplex deployment scenarios, in accordance with the present disclosure.

FIG. 6A is a diagram illustrating examples of different duplexing modes, in accordance with the present disclosure.

FIG. 6B is a diagram illustrating an example of sub-band full-duplex (SBFD) activation, in accordance with the present disclosure.

FIG. 7 is a diagram illustrating examples of dynamic or conditional UE SBFD configurations, in accordance with the present disclosure.

FIG. 8 is a diagram illustrating an example associated with a UE-initiated duplexing configuration.

FIG. 9 is a flowchart illustrating an example process performed, for example, by a UE in accordance with the present disclosure.

FIG. 10 is a flowchart illustrating an example process performed, for example, by a network node in accordance with the present disclosure.

FIG. 11-12 are diagrams of example apparatuses for wireless communication in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some cases, a wireless network may support full-duplex communication, which generally includes simultaneous bi-directional communication between devices in the wireless network. For example, a network node operating in a full-duplex mode may receive an uplink communication and transmit a downlink communication at the same time (e.g., in the same slot or the same symbol). For example, a network node and/or a UE may support a sub-band full-duplex (SBFD) communication mode. In the SBFD mode, a network node may receive an uplink communication from a first UE in an uplink sub-band and may simultaneously transmit a downlink communication to a second UE in a downlink sub-band (e.g., where simultaneous reception and transmission occurs in different frequency resources). For example, the uplink sub-band and the downlink sub-band may be different sub-bands within a frequency band or a component carrier, such as a time division duplexing (TDD) band. In this case, frequency resources used for downlink communication may be separated from frequency resources used for uplink communication, in the frequency domain, by one or more guard bands. In this way, the SBFD mode may result in increased throughput by allowing simultaneous uplink and downlink communication, reduced latency by allowing uplink and/or downlink communication to occur earlier in time, and/or increased spectral efficiency by simultaneously utilizing downlink and uplink resources.

As described herein, SBFD operation may be a capability that is supported by a network node only, a UE only, or both a network node and a UE. Furthermore, network nodes and UEs may generally support a legacy half-duplex communication mode, where a network node only transmits a downlink communication to a UE or only receives an uplink communication from the UE in any particular transmission time interval (TTI). Accordingly, in some cases, a duplexing mode or duplexing configuration can be semi-statically or dynamically switched or otherwise configured in different TTIs, such as different symbols or slots (e.g., depending on one or more conditions, such as self-interference at a network node or a UE that supports SBFD operation, an uplink and/or downlink traffic demand, and/or an uplink and/or downlink traffic periodicity, among other examples). For example, in any particular TTI, communication may be configured in a legacy half-duplexing mode (e.g., where a network node and a UE communicate using half-duplexing), a network node SBFD mode (e.g., where a network node operating in SBFD mode simultaneously communicates on a downlink with a first UE and on an uplink with a second UE), a network node and UE SBFD mode (e.g., where a network node and a UE both operate in an SBFD mode), or a UE SBFD mode (e.g., where a UE operating in SBFD mode simultaneously communicates on a downlink with a first transmission reception point (TRP) and on an uplink with a second TRP). In general, when SBFD operation is configured (e.g., at a network node and/or a UE), the network node configures the SBFD time resources (e.g., the symbols and/or slots that support SBFD communication) and the SBFD frequency resources (e.g., downlink and uplink sub-bands), and signals the appropriate parameters to an SBFD-aware UE (e.g., a UE that has received an indication of an SBFD configuration in use at a network node). However, there may be cases where a UE is aware of an upcoming uplink and/or downlink traffic pattern. In such cases, the UE may be unable to request or otherwise initiate a change to the duplexing pattern to accommodate the upcoming uplink and/or downlink traffic pattern.

Various aspects relate generally to techniques to enable a UE-initiated time window in which each TTI (e.g., symbol and/or slot) during the time window includes an uplink transmission opportunity to accommodate an uplink-heavy traffic pattern and/or an SBFD or full-duplexing (e.g., simultaneous uplink and downlink) opportunity to accommodate an uplink-heavy and downlink-heavy traffic pattern. For example, in some aspects, a UE may predict an upcoming uplink traffic pattern using one or more artificial intelligence or machine learning (AI/ML) models and/or based on a historical or future traffic pattern associated with the UE. Additionally, or alternatively, the UE may predict an upcoming downlink traffic pattern using the one or more AI/ML models, the historical or future traffic pattern associated with the UE, and/or an indication from a network node that relates to an actual or predicted downlink traffic buffer pattern associated with the UE. Accordingly, in cases where the UE predicts an uplink-heavy traffic pattern, the UE can transmit, to the network node, signaling to initiate a time window in which each symbol, slot, or other TTI includes an uplink transmission opportunity (e.g., requesting a switch to a UE SBFD mode, a network node SBFD mode, and/or an uplink-only half-duplexing mode). Alternatively, in cases where the UE predicts an uplink-heavy and downlink-heavy traffic pattern, the UE can transmit, to the network node, signaling to initiate a time window in which each symbol, slot, or other TTI includes an uplink transmission opportunity and a downlink reception opportunity (e.g., requesting a switch to a UE SBFD mode).

Particular aspects of the subject matter described in this disclosure can be implemented to realize one or more of the following potential advantages. In some examples, by enabling a UE to initiate or request a time window in which each symbol, slot, or TTI supports uplink communication or full-duplexing communication, the UE may satisfy latency requirements, throughput requirements, and/or other quality of service (QOS) requirements when the UE is expected to experience a period of uplink-heavy traffic and/or a period of uplink-heavy and downlink-heavy traffic.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or AI/ML, among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

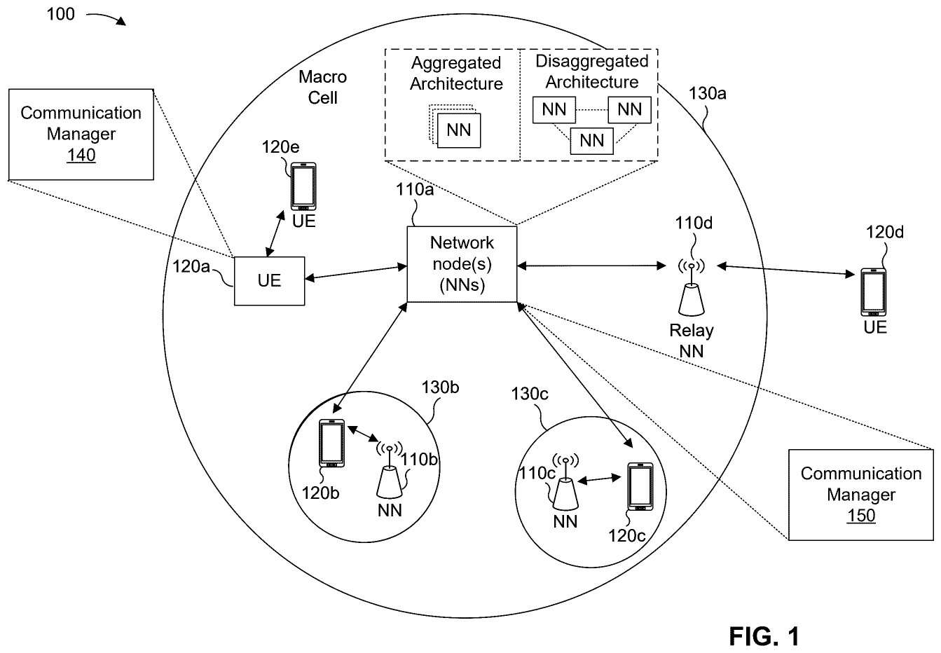

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHZ, FR1 is often referred to (interchangeably) as a “Sub-6 GHZ” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a TRP, a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may transmit, to a network node 110, signaling to initiate a time window with support for uplink communication in each interval within the time window based on a predicted uplink traffic pattern during the time window; receive, from the network node 110, signaling that indicates a duplexing configuration during the time window; and transmit, to the network node 110, one or more uplink communications during the time window in accordance with the duplexing configuration. Additionally, or alternatively, the communication manager 140 may perform one or more other operations described herein.

In some aspects, the network node 110 may include a communication manager 150. As described in more detail elsewhere herein, the communication manager 150 may receive, from a UE 120, signaling to initiate a time window with support for uplink communication in each interval within the time window based on a predicted uplink traffic pattern during the time window; transmit, to the UE 120, signaling that indicates a duplexing configuration during the time window; and receive, from the UE 120, one or more uplink communications during the time window in accordance with the duplexing configuration. Additionally, or alternatively, the communication manager 150 may perform one or more other operations described herein.

As indicated above, FIG. 1 is provided as an example. Other examples may differ from what is described with regard to FIG. 1.

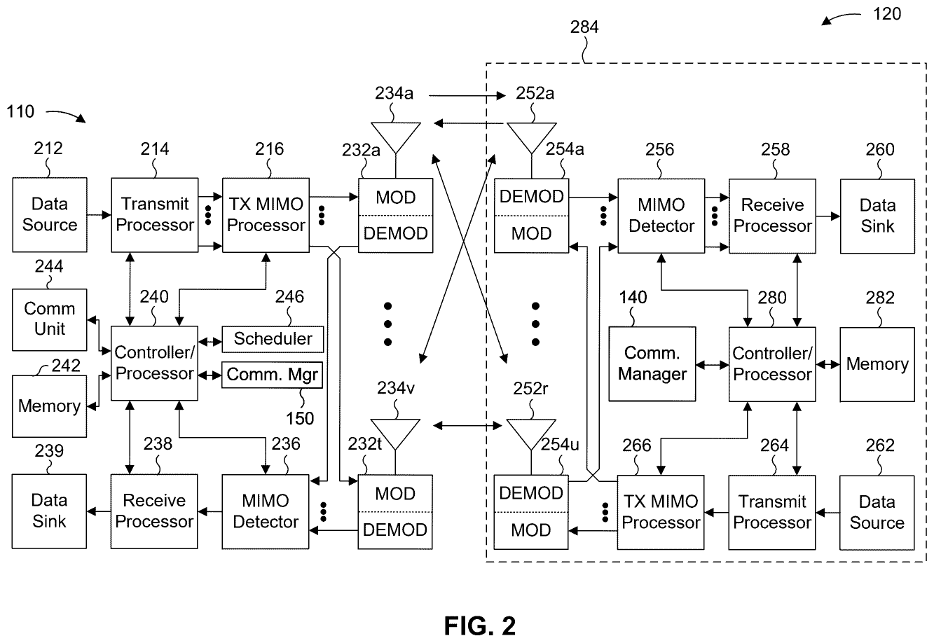

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

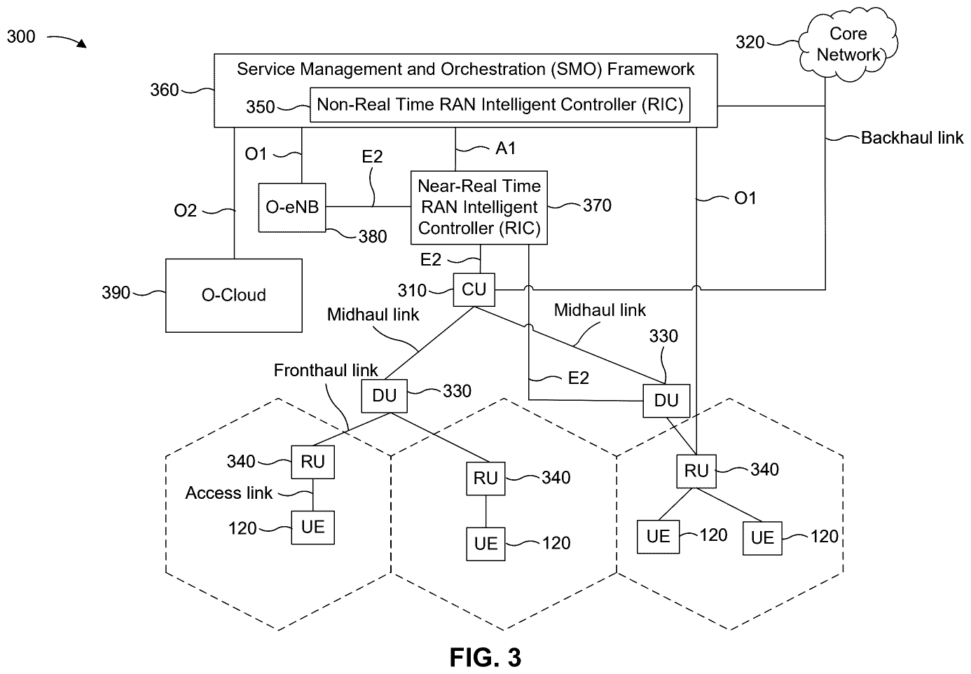

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

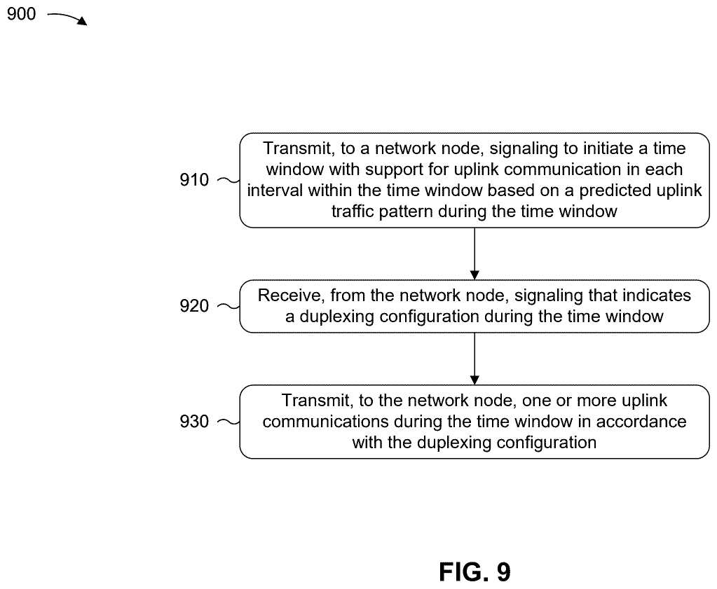

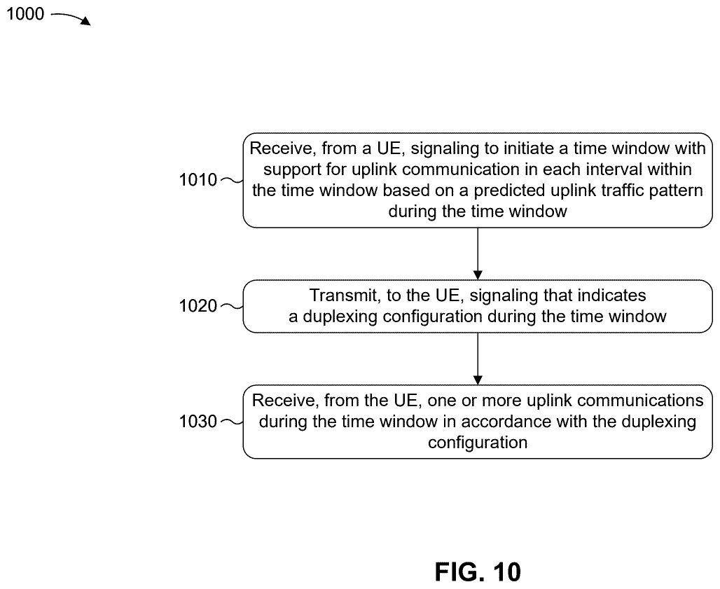

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with a UE-initiated duplexing configuration, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 900 of FIG. 9, process 1000 of FIG. 10, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

In some aspects, the UE 120 includes means for transmitting, to a network node 110, signaling to initiate a time window with support for uplink communication in each interval within the time window based on a predicted uplink traffic pattern during the time window; means for receiving, from the network node 110, signaling that indicates a duplexing configuration during the time window; and/or means for transmitting, to the network node 110, one or more uplink communications during the time window in accordance with the duplexing configuration. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving, from a UE 120, signaling to initiate a time window with support for uplink communication in each interval within the time window based on a predicted uplink traffic pattern during the time window; means for transmitting, to the UE 120, signaling that indicates a duplexing configuration during the time window; and/or means for receiving, from the UE 120, one or more uplink communications during the time window in accordance with the duplexing configuration. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

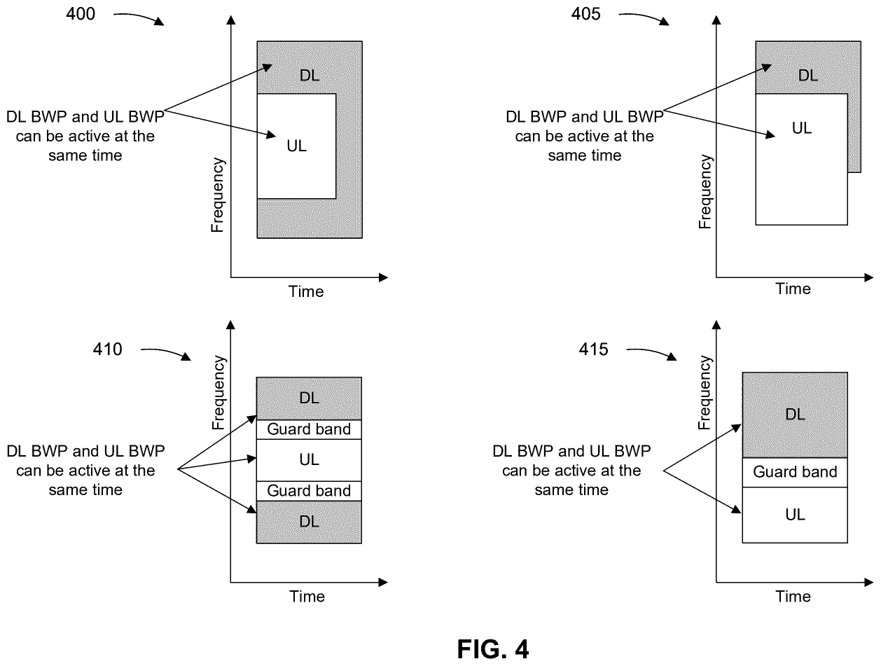

FIG. 4 is a diagram illustrating examples 400, 405, 410, and 415 of full-duplex communication in a wireless network, in accordance with the present disclosure. As described herein, “full-duplex communication” refers to simultaneous uplink and downlink communication in a wireless network, which may be a capability of a UE, a network node, or another suitable device (e.g., a mobile termination (MT) component and/or a forwarding (FWD) component of a network-controlled repeater (NCR)). For example, a UE operating in a full-duplex mode may transmit an uplink communication and receive a downlink communication at the same time (e.g., in the same slot or the same symbol), and a network node operating in a full-duplex mode may receive an uplink communication and transmit a downlink communication at the same time. “Half-duplex communication” in a wireless network refers to unidirectional communications (e.g., only downlink communication or only uplink communication) at a given time (e.g., a device only transmits or only receives in a given slot or a given symbol). In some cases, one or more nodes in a wireless network may support full-duplex communication and half-duplex communication, and other nodes may support half-duplex communication only. For example, in some aspects, a network node may support full-duplex and half-duplex communication, and one or more UEs may support half-duplex communication only.

As shown in FIG. 4, examples 400 and 405 show examples of in-band full-duplex (IBFD) communication. In a scenario where a network node supports IBFD and a UE supports half-duplex communication only, the network node may receive an uplink communication from a first UE and may transmit a downlink communication to a second UE on the same time and frequency resources. As shown in example 400, in a first example of IBFD, the time and frequency resources for uplink communication may fully overlap with the time and frequency resources for downlink communication (e.g., all time and frequency resources allocated to uplink communication are also available for downlink communication). As shown in example 405, in a second example of IBFD, the time and frequency resources for uplink communication may partially overlap with the time and frequency resources for downlink communication (e.g., some time and frequency resources are reserved for uplink communication only).

As further shown in FIG. 4, examples 410 and 415 show examples of SBFD communication, which may also be referred to as “sub-band frequency division duplex (SBFDD),” “flexible duplex,” or “FDD in unpaired spectrum.” In some aspects, an SBFD communication mode may be supported by a network node only, by a network node and a UE, by a UE only, and/or any suitable combination thereof. In the SBFD communication mode, a node operating in accordance with an SBFD configuration may simultaneously transmit and receive different communications at the same time, but on different frequency resources. For example, a network node operating in an SBFD mode may simultaneously receive an uplink communication from a first UE in an uplink sub-band and transmit a downlink communication to a second UE in a downlink sub-band, where the uplink sub-band and the downlink sub-band may occupy different frequency resources. Similarly, a UE operating in an SBFD mode may simultaneously transmit an uplink communication to a network node in an uplink sub-band and receive a downlink communication from the network node in a downlink sub-band. For example, the uplink sub-band and the downlink sub-band may be sub-bands of a frequency band, such as a TDD band, or a component carrier of a frequency band. In this case, the frequency resources used for downlink communication may be separated from the frequency resources used for uplink communication, in the frequency domain, by one or more guard bands. For example, as shown in example 410, SBFD communication may be configured in a D+U+D pattern, where an uplink sub-band is configured between a first (upper) downlink sub-band and a second (lower) downlink sub-band, with a first guard band separating the uplink sub-band from the first downlink sub-band and a second guard band separating the uplink sub-band from the second downlink sub-band. Additionally, or alternatively, as shown in example 415, SBFD communication may be configured in a D+U pattern, where a component carrier bandwidth or frequency band is partitioned into a downlink sub-band and an uplink sub-band that are separated by a guard band.

As indicated above, FIG. 4 is provided as an example. Other examples may differ from what is described with regard to FIG. 4.

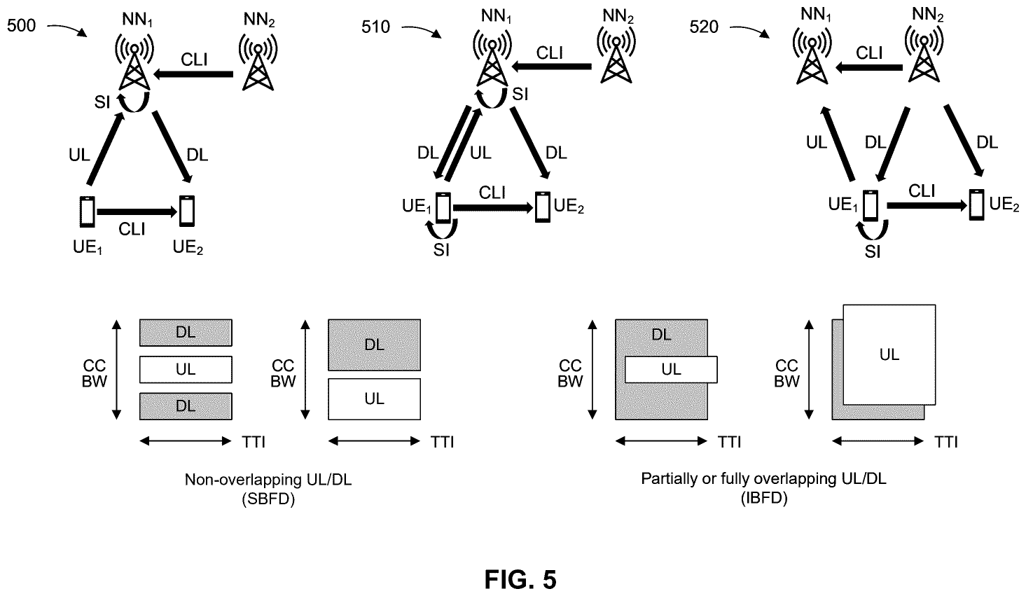

FIG. 5 is a diagram illustrating examples 500, 510, 520 of full-duplex deployment scenarios, in accordance with the present disclosure. As shown in FIG. 5, examples 500, 510, 520 include one or more UEs in communication with one or more network nodes in a wireless network that supports full-duplex communication. In general, as described herein, utilizing a full-duplexing communication mode may provide reduced latency by allowing a downlink transmission to occur in an uplink-only symbol or slot and/or by allowing an uplink transmission to occur in a downlink-only or flexible symbol or slot. In addition, full-duplex communication may increase an uplink duty cycle, which may improve uplink coverage, may enhance spectral efficiency or throughput per cell or per UE, may increase system capacity, may enable more efficient resource utilization by simultaneously utilizing time and frequency resources for downlink and uplink communication, and/or may enable flexible and dynamic uplink and downlink resource adaptation according to uplink and/or downlink traffic patterns. However, as described in further detail herein, full-duplexing communication modes may be associated with dynamic interference conditions.

For example, as shown in FIG. 5, example 500 includes a first UE (shown as UE₁) and a second UE (shown as UE₂) in communication with a first network node (shown as NN₁) operating in a full-duplexing mode, with the first UE and the second UE operating in a half-duplexing mode. For example, as shown in FIG. 5, the first UE may transmit one or more uplink transmissions to the first network node, and the second UE may concurrently receive one or more downlink transmissions from the first network node. Accordingly, in example 500, the first network node is operating in a full-duplexing mode, and the first UE and the second UE are each operating in a half-duplexing mode. As shown by example 500, there may be various forms of interference that may degrade downlink reception performance at one or more UEs and/or uplink reception performance at the first network node operating in the full-duplexing mode. For example, as shown, the first network node may experience cross-link interference (CLI) caused by downlink transmissions from a second network node (shown as NN₂) that may be located in an adjacent or nearby cell. Furthermore, as shown, the uplink transmission from the first UE to the first network node may cause CLI at the second UE (e.g., CLI that interferes with downlink reception at the second UE). Furthermore, as shown, the first network node may experience self-interference, where the downlink transmission to the second UE interferes with reception of the uplink transmission from the first UE. For example, as described herein, self-interference may generally occur when a transmitted signal leaks into a receive port and/or when an object in a surrounding environment reflects a transmitted signal back to a receive port (e.g., causing a clutter echo effect), thus interfering with reception of a desired signal at the receive port. In general, the full-duplexing mode used by the first network node in example 500 may be an SBFD mode, where a component carrier bandwidth is divided into an uplink sub-band and one or more downlink sub-bands that are separated by one or more guard bands. Additionally, or alternatively, the full-duplexing mode may be an IBFD mode, where uplink and downlink resources fully or partially overlap.

As further shown in FIG. 5, in example 510, a first UE may communicate with a first network node in a full-duplexing mode. For example, in example 510, the first UE may receive one or more downlink transmissions from the first network node, and the first UE may concurrently transmit one or more uplink transmissions to the first network node. Accordingly, in example 510, the first network node and the first UE are both operating in a full-duplexing (e.g., SBFD or IBFD) mode. Furthermore, as shown, the first network node may be communicating with a second UE operating in a half-duplexing mode. As shown by example 510, the first UE may experience self-interference, where the uplink transmission to the first network node interferes with reception of the downlink transmission from the first network node, and the first UE may cause CLI at the second UE, where the uplink transmission to the first network node interferes with downlink reception at the second UE. Additionally, in example 510, the first network node may experience CLI caused by one or more downlink transmissions from a second network node interfering with reception of the uplink transmission from the first UE, and the first network node may experience self-interference, where downlink transmission(s) to the first UE and/or the second UE interferes with reception of the uplink transmission from the first UE. In example 510, the full-duplex communication may be performed in an SBFD mode or an IBFD mode.

As further shown in FIG. 5, in example 520, a first UE may communicate with a first network node and a second network node in a full-duplexing mode (e.g., a multi-TRP mode). For example, in example 520, the first UE may transmit one or more uplink transmissions to the first network node (e.g., a first TRP), and the first UE may concurrently receive one or more downlink transmissions from the second network node (e.g., a second TRP). Accordingly, in example 520, the first UE is operating in a full-duplexing mode, and the first and second network nodes are both operating in a half-duplexing mode. As shown by example 520, the first UE may experience self-interference, where the uplink transmission to the first network node interferes with reception of the downlink transmission from the second network node. Furthermore, the uplink transmission by the first UE may cause CLI at a second UE receiving a downlink transmission from the second network node. Furthermore, as shown, the downlink transmission by the second network node may cause CLI that interferes with uplink reception at the first network node. In example 520, the full-duplex communication may be performed in an SBFD mode or an IBFD mode.

As indicated above, FIG. 5 is provided as an example. Other examples may differ from what is described with regard to FIG. 5.

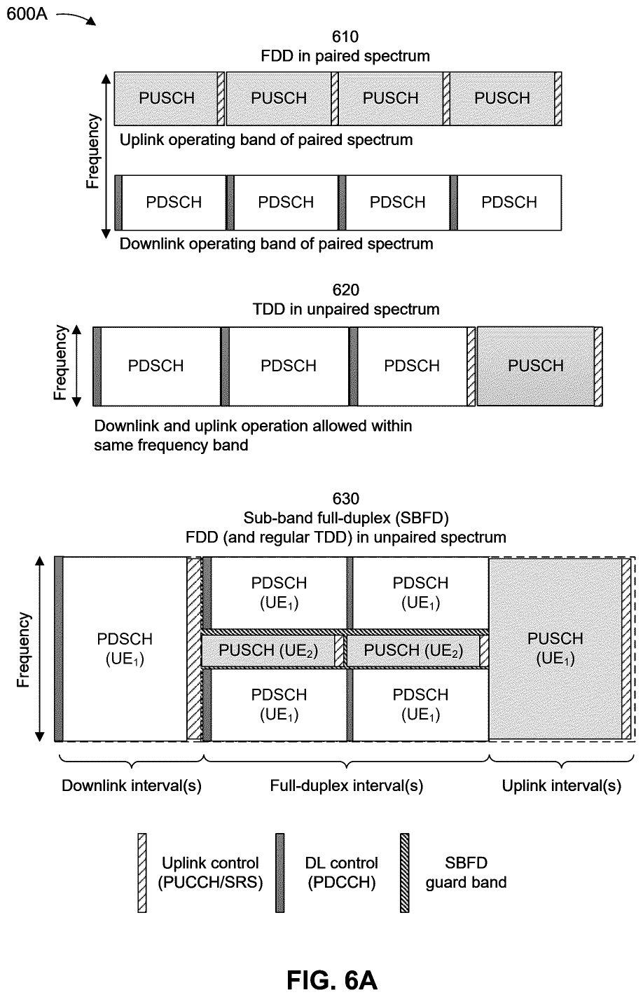

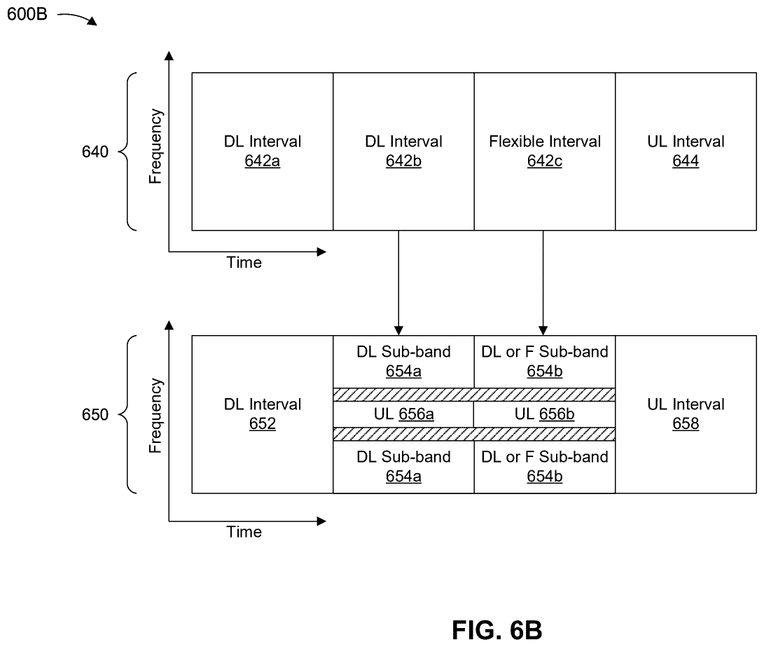

FIG. 6A is a diagram illustrating examples 600A of different duplexing modes, and FIG. 6B is a diagram illustrating an example 600B of SBFD activation, in accordance with the present disclosure. For example, as described in further detail herein, FIG. 6A illustrates an example 610 of an FDD mode that may be used in paired spectrum, an example 620 of a TDD mode that may be used in unpaired spectrum, and an example 630 of an SBFD mode that may be used in unpaired spectrum, and FIG. 6B illustrates an example 600B of techniques that may be used to activate the SBFD mode.

In some aspects, a wireless communication standard and/or governing body may generally specify one or more duplexing modes in which a wireless spectrum is to be used. For example, 3GPP may specify how wireless spectrum is to be used for a RAT and/or air interface. As an example, a specification may indicate whether a band is to be used as paired spectrum in an FDD mode, as unpaired spectrum in a TDD mode, or another duplexing mode (e.g., SBFD).

For example, as shown by example 610, paired spectrum in the FDD mode may use a first frequency region (or channel) for uplink communication and a second frequency region (or channel) for downlink communication. In such cases, the frequency regions or channels used for uplink communication and downlink communication do not overlap, have different center frequencies, and have sufficient separation to prevent interference between the downlink communication and the uplink communication. For example, paired spectrum in FDD mode may include an uplink operating band and a downlink operating band that are configured to use non-overlapped frequency regions separated by a guard band. Accordingly, when operating in the FDD mode in paired spectrum, a network node or a UE with full-duplex capabilities may perform concurrent transmit and receive operations using the separate operating bands allocated to downlink and uplink communication. For example, paired bands in NR include NR operating bands n1, n2, n3, n5, n7, n8, n12, n20, n25, and n28, as specified by 3GPP Technical Specification (TS) 38.101-1.

Alternatively, as shown by example 620, unpaired spectrum in the TDD mode may allow downlink and uplink operation within a single frequency region (e.g., a single operating band). For example, when operating in TDD mode in unpaired spectrum, downlink communication and uplink communication may occur in the same frequency resources. Some deployments may use TDD or a legacy half-duplexing mode in the unpaired band, whereby some TTIs (e.g., frames, slots, and/or symbols) are used for downlink communication only and other TTIs are used for uplink communication only. In this case, substantially the entire bandwidth of a component carrier may be used for downlink communication or uplink communication, depending on whether the communication is performed in a downlink-only interval, an uplink-only interval, or a flexible interval (in which either downlink or uplink communication can be scheduled). Examples of unpaired bands include NR operating bands n40, n41, and n50, as specified by 3GPP TS 38.101-1. In some cases, however, using TDD in unpaired spectrum may be inefficient. For example, uplink transmit power may be limited, meaning that UEs may be incapable of transmitting with enough power to efficiently utilize the full component carrier bandwidth in an uplink interval. This may be particularly problematic in large cells at the cell edge. Furthermore, using TDD may introduce latency relative to a full-duplexing scheme in which uplink communications and downlink communications can be performed in the same time interval, because TDD restricts usage of a given TTI to uplink-only or downlink-only. Furthermore, using TDD may reduce spectral efficiency and/or reduce throughput by restricting usage of a given TTI to uplink-only or downlink-only.

Accordingly, as shown by example 630, an unpaired band may be configured in a full-duplexing mode to enable concurrent transmit and receive operations in unpaired spectrum (e.g., a TDD band). For example, in FIG. 6A, example 630 depicts an SBFD mode, which may be referred to as full-duplexing in a frequency division multiplexing (FDM) mode or other suitable terminology, in order to enable TDD operation and/or FDD operation in unpaired spectrum. For example, as shown in FIG. 6A, an unpaired band configured in the SBFD mode may associate one or more TTIs with downlink communication only (e.g., “D” slots), one or more TTIs for uplink communication only (e.g., “U” slots), and one or more TTIs for both downlink communication and uplink communication (e.g., “D+U” slots). Each TTI may be associated with a control region, illustrated as a portion of a time interval with a diagonal fill for uplink control (e.g., a PUCCH) or a darker-shaded fill for downlink control (e.g., a PDCCH). Additionally, or alternatively, each TTI may be associated with a data region, which is shown as a PDSCH for downlink frequency regions or a PUSCH for uplink frequency regions.

In some aspects, an unpaired band configured in the SBFD mode may include one or more downlink-only time intervals, one or more uplink-only time intervals, and/or one or more full-duplex time intervals (e.g., frames, subframes, slots, and/or symbols, among other examples) that are associated with an FDD configuration. For example, as shown in FIG. 6A, the FDD configuration associated with a full-duplex time interval may indicate one or more downlink frequency regions (or sub-bands) and one or more uplink frequency regions (or sub-bands) that are separated by a guard band. For example, as shown by example 630, SBFD communication may be configured in a D+U+D pattern, where an uplink sub-band is configured between a first (upper) downlink sub-band and a second (lower) downlink sub-band, with a first guard band separating the uplink sub-band from the first downlink sub-band and a second guard band separating the uplink sub-band from the second downlink sub-band. Additionally, or alternatively, SBFD communication may be configured in a D+U pattern (not explicitly shown in FIG. 6A), where a component carrier bandwidth or frequency band is partitioned into a downlink sub-band and an uplink sub-band that are separated by a guard band. Accordingly, an FDD configuration may divide an unpaired frequency band (e.g., one or more component carriers of an unpaired band) into uplink frequency regions, downlink frequency regions, and/or other regions (e.g., guard bands, control regions, or the like), which may enable a network node or a UE with full-duplex capabilities to perform simultaneous transmit and receive operations during one or more full-duplex time intervals in which frequency resources are divided into downlink and uplink sub-bands with a guard band separation to prevent an uplink transmission from causing self-interference with respect to downlink reception. For example, in a given full-duplex time interval, a half-duplexing UE may either transmit using the uplink frequency region or receive in the downlink frequency region (e.g., a UE communicating in a half-duplexing mode may only receive in a downlink frequency region or transmit in an uplink frequency region during the full-duplex time intervals). Alternatively, a full-duplexing UE may transmit using the uplink frequency region and/or receive in the downlink frequency region. Additionally, or alternatively, a full-duplexing network node may transmit a downlink communication to a first UE within the downlink frequency regions(s) and simultaneously receive an uplink communication from a second UE in the uplink frequency region(s). In some aspects, the FDD configuration may identify BWP configurations corresponding to the uplink frequency regions and the downlink frequency regions. For example, a respective BWP may be configured for each uplink frequency region and each downlink frequency region.

Additionally, or alternatively, full-duplexing may be enabled in unpaired spectrum in an IBFD mode, which may be referred to herein as full-duplexing in a spatial division multiplexing (SDM) mode. For example, in an IBFD mode or a full-duplexing in SDM mode, uplink communication may occur on time and frequency resources that fully overlap time and frequency resources allocated to downlink communication (e.g., all of the time and frequency resources available for uplink communication are also available for downlink communication). Alternatively, uplink communication may occur on time and frequency resources that partially overlap with time and frequency resources available for downlink communication (e.g., some time and frequency resources available for uplink communication are also available for downlink communication and some time and frequency resources available for uplink communication are uplink-only). In general, in the SBFD mode and/or the IBFD mode, full-duplex communication may be conditional on sufficient beam separation between an uplink beam and a downlink beam (e.g., uplink transmission may be from one antenna panel and downlink reception may be in another antenna panel) in order to minimize self-interference that may occur when a transmitted signal leaks into a receive port and/or when an object in a surrounding environment reflects a transmitted signal back to a receive port (e.g., causing a clutter echo effect).

In some cases, as described herein, one or more frequency regions that support SBFD communication may be configured to dynamically switch between operating in a TDD mode (e.g., a half-duplexing mode in which each slot or symbol is uplink-only or downlink-only, also referred to as duplexing mode 1, a legacy half-duplexing mode, or the like) and one or more SBFD modes. For example, in a scenario where only a network node supports SBFD operation, one or more downlink or flexible slots or symbols can be semi-statically or dynamically configured in a first SBFD mode (referred to as duplexing mode 2, a network node SBFD mode, or the like) in which the network node simultaneously transmits a downlink communication to a first UE in one or more downlink sub-bands and receives an uplink communication from a second UE in an uplink sub-band, and any other slots or symbols may be configured in the legacy half-duplexing (e.g., downlink-only or uplink-only). Furthermore, in cases where a UE supports SBFD operation, one or more slots or symbols can be configured in a second SBFD mode (referred to as duplexing mode 3, a UE and network node SBFD mode, or the like) in which a network node operating in SBFD mode communicates with a UE operating in SBFD mode or in a third SBFD mode (referred to as duplexing mode 4, a UE SBFD mode, or the like) in which a UE operating in SBFD mode communicates with a first TRP operating in a half-duplexing mode and a second TRP operating in a half-duplexing mode. In general, the second and third SBFD modes may be similar from a UE perspective, and may be transparent to an SBFD-capable UE in cases where two TRPs or cells are associated with the same cell or DU. Furthermore, although some aspects are described herein in relation to SBFD operation, the same or similar techniques may be applicable to partial or fully overlapping full-duplex (e.g., IBFD) operation.

For example, as shown in FIG. 6B, a first configuration 640 (e.g., a legacy or default configuration associated with the TDD mode) may indicate a first slot format pattern or TDD pattern associated with a half-duplex mode (e.g., where each interval is downlink-only, uplink-only, or flexible such that the interval can be configured to be a downlink interval or an uplink interval). The first slot format pattern may include one or more downlink intervals (e.g., shown as two downlink intervals 642a and 642b), one or more flexible intervals (e.g., shown as one flexible interval 642c), and/or one or more uplink intervals (e.g., shown as one uplink interval 644). The first slot format pattern may repeat over time. In some aspects, a network node 110 may indicate the first slot format pattern to a UE 120 using one or more slot format indicators. A slot format indicator, for a slot, may indicate whether the corresponding slot is an uplink slot, a downlink slot, or a flexible slot (e.g., that can be used as an uplink or downlink slot).

A network node 110 may instruct (e.g., using an indication, such as an RRC message, a MAC-CE, or a DCI message) a UE 120 to switch from the first configuration 640 to a second configuration 650. As an alternative, the UE 120 may indicate to the network node 110 that the UE 120 is switching from the first configuration 640 to the second configuration 650. The second configuration 650 may indicate a second slot format pattern that repeats over time, similar to the first slot format pattern. In some aspects, the UE 120 may switch from the first configuration 640 to the second configuration 650 during a time period (e.g., a quantity of symbols and/or an amount of time) in accordance with an indication received from the network node 110 (e.g., before switching back to the first configuration 640). During the time period, the UE 120 may communicate using the second slot format pattern, and then may revert to using the first slot format pattern after the end of the time period. The time period may be indicated by the network node 110 (e.g., in the instruction to switch from the first configuration 640 to the second configuration 650, as described above) and/or associated with a programmed and/or otherwise preconfigured rule. For example, the rule may be based at least in part on a table (e.g., defined in 3GPP specifications and/or another wireless communication standard) that associates different subcarrier spacings (SCSs) and/or numerologies (e.g., represented by a u parameter and associated with corresponding SCSs) with corresponding time periods for switching configurations.

In example 600B, the second slot format pattern includes two SBFD intervals, which include a first SBFD interval in place of downlink interval 642b in the first slot format pattern and a second SBFD interval in place of flexible interval 642c in the first slot format pattern. In example 600B, the second slot format pattern includes a downlink interval 652, which is followed by the first SBFD interval that includes a downlink sub-band (e.g., a portion of a frequency allocated for use by the network node 110 and the UE 120, shown as downlink sub-bands 654a) and an uplink sub-band (e.g., shown as uplink sub-band 656a). For example, when an interval configured as downlink-only (e.g., downlink interval 642b) is switched to or otherwise configured for SBFD operation, uplink transmissions within the uplink sub-band (e.g., uplink sub-band 656a) are allowed within the interval, and uplink transmissions outside the uplink sub-band are not allowed within the interval. Furthermore, frequency locations of the downlink sub-band(s) (e.g., downlink sub-bands 654a) can be explicitly indicated to the UE 120 or implicitly derived by the UE 120, and downlink reception within the downlink sub-band(s) is allowed in the interval.

As further shown in example 600B, the first SBFD interval is followed by a second SBFD interval, which includes one or more sub-bands that may be configured as downlink sub-bands or flexible sub-bands (e.g., shown as sub-bands 654b) and an uplink sub-band (e.g., shown as uplink sub-band 656b). For example, when an interval configured as flexible (e.g., flexible interval 642c) is switched to or otherwise configured for SBFD operation, uplink transmissions within the uplink sub-band (e.g., uplink sub-band 656b) are allowed within the interval, and uplink transmissions outside the uplink sub-band are not allowed within the interval. Alternatively, a set of resource blocks (RBs) outside the uplink sub-band 656b may be used for uplink communication, or for downlink communication excluding any guard bands, and a transmission direction for all RBs outside the uplink sub-band 656b is the same within the interval (e.g., the UE 120 cannot use separate RBs outside the uplink sub-band 656b for downlink and uplink communication). Furthermore, frequency locations of the downlink sub-band(s) (e.g., downlink sub-bands 654b) can be explicitly indicated to the UE 120 or implicitly derived by the UE 120, and downlink reception within the downlink sub-band(s) is allowed in the interval. As further shown, the second SBFD interval is followed by an uplink interval 658.

Accordingly, the UE 120 may operate using the second slot format pattern to transmit an uplink communication in an earlier interval (e.g., the second interval in the sequence shown in FIG. 6B) as compared to using the first slot format pattern (e.g., the fourth interval in sequence, shown as uplink interval 644). Other examples may include additional or alternative changes. For example, the second configuration 650 may indicate an SBFD interval in place of what was an uplink interval in the first configuration 640 (e.g., uplink interval 644). In another example, the second configuration 650 may indicate a downlink interval or an uplink interval in place of what was an SBFD interval in the first configuration 640 (not shown in FIG. 6B). In yet another example, the second configuration 650 may indicate a downlink interval or an uplink interval in place of what was an uplink interval or a downlink interval, respectively, in the first configuration 640.

As described herein, an SBFD interval may generally include a frame, a slot, a symbol, or another TTI in which an SBFD configuration is used. An SBFD configuration may include a frequency resource configuration in which full duplex communication is supported (e.g., for both uplink and downlink communications), with one or more frequencies or sub-bands used for uplink communication being separated from one or more frequencies or sub-bands used for downlink communication by a guard band. In some aspects, the SBFD configuration may include a single uplink sub-band and a single downlink sub-band separated by a guard band. In some aspects, the SBFD configuration may include multiple downlink sub-bands and a single uplink sub-band that is separated from the multiple downlink sub-bands by respective guard bands (e.g., as shown in FIG. 6B). In some aspects, an SBFD configuration may include multiple uplink sub-bands and a single downlink sub-band that is separated from the multiple uplink sub-bands by respective guard bands. In some aspects, the SBFD configurations may include multiple uplink sub-bands and multiple downlink sub-bands, where each uplink sub-band is separated from a downlink sub-band by a guard band. In some aspects, operating using an SBFD mode may include activating or using a full-duplexing mode in one or more slots, symbols, or other intervals based at least in part on the one or more intervals having the SBFD configuration. An interval may support the SBFD mode if an uplink bandwidth part and a downlink bandwidth part are permitted to be or are simultaneously active in accordance with an SBFD configuration (e.g., with guard band separation).

By switching from the first configuration 640 to the second configuration 650, the network node 110 and/or the UE 120 may experience increased quality and/or reliability of communications. For example, the network node 110 and the UE 120 may experience increased throughput (e.g., using a full-duplex mode), reduced latency (e.g., the UE 120 may be able to transmit an uplink and/or a downlink communication sooner using the second configuration 650 rather than the first configuration 640), increased network resource utilization (e.g., by using both downlink frequency resources and uplink frequency resources simultaneously instead of only the downlink frequency resources or the uplink frequency resources), improved uplink coverage, and/or flexible and dynamic uplink and downlink resource adaptation according to uplink and downlink traffic patterns, among other examples.

As indicated above, FIGS. 6A-6B are provided as examples. Other examples may differ from what is described with regard to FIGS. 6A-6B.

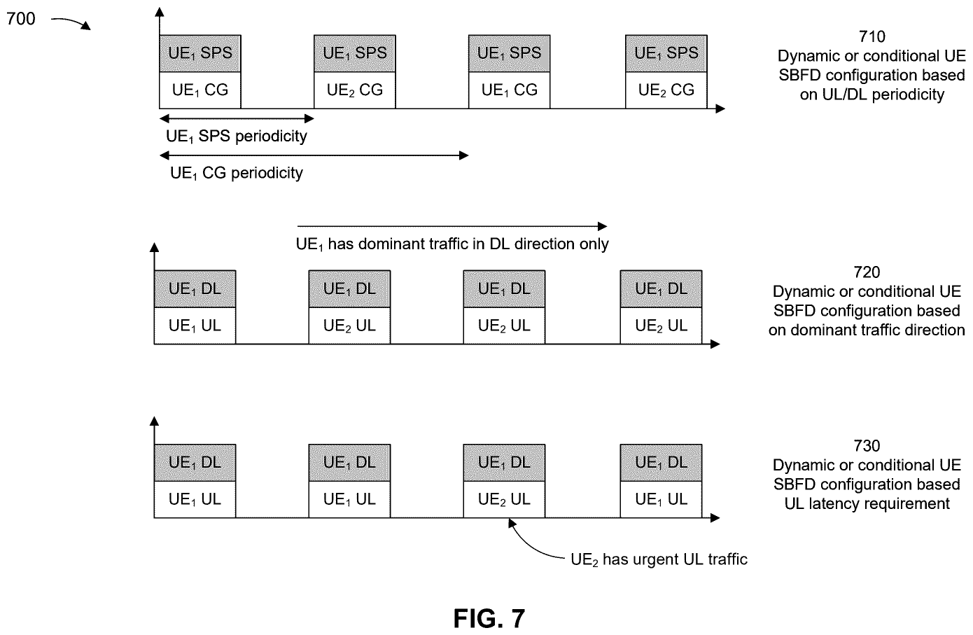

FIG. 7 is a diagram illustrating examples 700 of dynamic or conditional UE SBFD configurations, in accordance with the present disclosure. For example, as described herein, one or more frequency regions that support SBFD communication may be configured to dynamically switch between operating in a TDD mode (e.g., a half-duplexing mode in which each slot or symbol is uplink-only or downlink-only, also referred to as duplexing mode 1, a legacy half-duplexing mode, or the like) and one or more SBFD modes. For example, in a scenario where only a network node supports SBFD operation, one or more downlink or flexible slots or symbols can be semi-statically or dynamically configured in a first SBFD mode (referred to as duplexing mode 2, a network node SBFD mode, or the like) in which the network node simultaneously transmits a downlink communication to a first UE in one or more downlink sub-bands and receives an uplink communication from a second UE in an uplink sub-band, and any other slots or symbols may be configured in the legacy half-duplexing (e.g., downlink-only or uplink-only). Furthermore, in cases where a UE supports SBFD operation, one or more slots or symbols can be configured in a second SBFD mode (referred to as duplexing mode 3, a UE and network node SBFD mode, or the like) in which a network node operating in SBFD mode communicates with a UE operating in SBFD mode or in a third SBFD mode (referred to as duplexing mode 4, a UE SBFD mode, or the like) in which a UE operating in SBFD mode communicates with a first TRP operating in a half-duplexing mode and a second TRP operating in a half-duplexing mode. In general, the second and third SBFD modes may be similar from a UE perspective, and may be transparent to an SBFD-capable UE in cases where two TRPs or cells are associated with the same cell or DU.

Accordingly, in cases where a UE supports SBFD operation, a network node may configure the UE to simultaneously transmit in an uplink sub-band and receive in one or more downlink sub-bands (e.g., in duplexing mode 3 or duplexing mode 4) in one or more SBFD slots, SBFD symbols, or other SBFD intervals. However, the network node does not have to configure the SBFD-capable UE with SBFD resources in every interval, and may configure the SBFD-capable in a half-duplexing (e.g., downlink-only or uplink-only) mode in one or more intervals. For example, the network node may select a duplexing configuration for the SBFD-capable UE in accordance with one or more conditions.

For example, in some cases, the SBFD capability of the UE may be conditional or dynamic, where the UE may transmit a request or indication to the network node to switch the UE to a half-duplexing mode based on the SBFD-capable UE experiencing self-interference that satisfies (e.g., equals or exceeds) a threshold. Additionally, or alternatively, the duplexing configuration used in each interval may be conditional or dynamic based on a downlink or uplink traffic demand. For example, as shown by reference number 710, a first UE (shown as UE₁) may be associated with a configured grant (CG) configuration for grant-free uplink communication and a semi-persistent scheduling (SPS) configuration for grant-free downlink communication. In the example shown by reference number 710, the CG configuration has a larger periodicity than the SPS configuration, whereby some SPS occasions may be paired with a CG occasion for the first UE and other SPS occasions are not paired with a CG occasion for the first UE. Accordingly, in such cases, the network node may configure the first UE for SBFD operation in intervals where SPS occasions and CG coincide for the first UE, and in other occasions the network node may pair an SPS occasion of the first UE with a CG occasion of a second UE (shown as UE₂) to enable SBFD operation at the network node and half-duplexing operation at the first and second UEs.

In another example, as shown by reference number 720, the SBFD configuration of the first UE may be dynamic or conditional based on a dominant traffic direction. For example, as shown, downlink communication to the first (SBFD-capable) UE may be paired with uplink communication by a second UE for SBFD operation at the network node only, based on the first (SBFD-capable) UE having dominant traffic in a downlink direction only. In another example, as shown by reference number 730, the SBFD configuration of the first UE may be dynamic or conditional based on a latency requirement of another UE. For example, as shown in FIG. 7, a second UE may have urgent uplink traffic to transmit, in which case downlink communication to the first (SBFD-capable) UE may be paired with uplink communication by the second UE for SBFD operation at the network node only.

Accordingly, when SBFD operation is configured (e.g., at a network node and/or a UE), the network node typically configures the SBFD time resources (e.g., the symbols and/or slots that support SBFD communication) and the SBFD frequency resources (e.g., downlink and uplink sub-bands), and signals the appropriate parameters to an SBFD-aware or SBFD-capable UE. However, there may be cases where an SBFD-capable UE is aware of an upcoming uplink and/or downlink traffic pattern. In such cases, some aspects described herein relate to techniques to enable a UE-initiated time window in which each TTI (e.g., symbol and/or slot) during the time window includes an uplink transmission opportunity to accommodate an uplink-heavy traffic pattern and/or an SBFD or full-duplexing (e.g., IBFD) opportunity to accommodate an uplink-heavy and downlink-heavy traffic pattern. For example, in some aspects, a UE may predict an upcoming uplink traffic pattern using one or more AI/ML models and/or based on a historical or future traffic pattern associated with the UE. Additionally, or alternatively, the UE may predict an upcoming downlink traffic pattern using the one or more AI/ML models, the historical or future traffic pattern associated with the UE, and/or an indication from a network node that relates to an actual or predicted downlink traffic buffer pattern associated with the UE. Accordingly, in cases where the UE predicts an uplink-heavy traffic pattern, the UE can transmit, to the network node, signaling to initiate a time window in which each symbol, slot, or other TTI includes an uplink transmission opportunity (e.g., requesting a switch to a UE SBFD mode, a network node SBFD mode, and/or an uplink-only half-duplexing mode). Alternatively, in cases where the UE predicts an uplink-heavy and downlink-heavy traffic pattern, the UE can transmit, to the network node, signaling to initiate a time window in which each symbol, slot, or other TTI includes uplink transmission and downlink reception opportunities (e.g., requesting a switch to a UE SBFD mode).

As indicated above, FIG. 7 is provided as an example. Other examples may differ from what is described with regard to FIG. 4.

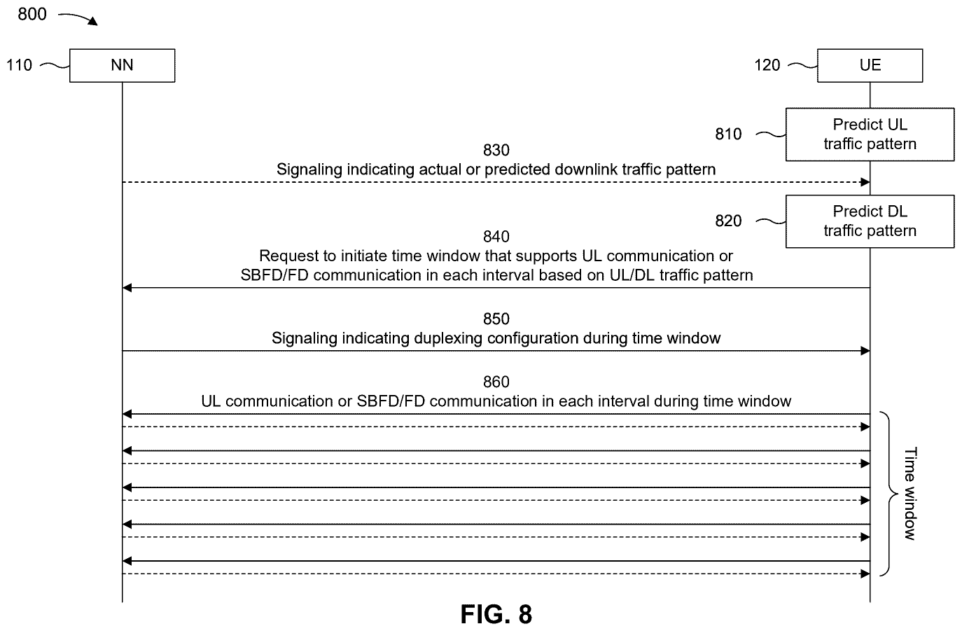

FIG. 8 is a diagram illustrating an example 800 associated with a UE-initiated duplexing configuration, in accordance with the present disclosure. As shown in FIG. 8, example 800 includes communication between a network node 110 and a UE 120. In some aspects, the network node 110 and the UE 120 may communicate in a wireless network, such as wireless network 100. The network node 110 and the UE 120 may communicate via a wireless access link, which may include an uplink and a downlink. In some aspects, SBFD operation and/or another full-duplexing (e.g., IBFD) operation may be supported by the network node 110, by the UE 120, or by the network node and the UE 120.

As shown in FIG. 8, and by reference number 810, the UE 120 may predict an uplink traffic pattern associated with the UE 120 over an upcoming time period. For example, in some aspects, the UE 120 may predict the uplink traffic pattern over the upcoming time period according to an output from one or more AI/ML models associated with the UE 120. Additionally, or alternatively, the UE 120 may predict the uplink traffic pattern according to a historical uplink traffic pattern associated with the UE 120 and/or a future uplink traffic pattern associated with the UE 120 (e.g., based on a status of one or more uplink buffers).

As shown in FIG. 8, and by reference number 820, the UE 120 may predict a downlink traffic pattern associated with the UE 120 over the upcoming time period. For example, in some aspects, the UE 120 may predict the downlink traffic pattern over the upcoming time period according to an output from one or more AI/ML models associated with the UE 120. Additionally, or alternatively, the UE 120 may predict the downlink traffic pattern according to a historical downlink traffic pattern (e.g., downlink reception history) associated with the UE 120. Additionally, or alternatively, the UE 120 may predict the downlink traffic pattern according to information that is signaled by the network node 110. For example, as shown by reference number 830, the network node 110 may transmit or otherwise provide, and the UE 120 may receive, signaling or information that indicates an actual downlink traffic buffer pattern associated with the UE 120 (e.g., pending downlink traffic to be transmitted to the UE 120). Additionally, or alternatively, the signaling or information transmitted by the network node 110 may indicate a predicted downlink traffic buffer pattern associated with the UE 120 according to an output from one or more AI/ML models associated with the network node 110.

Accordingly, as described herein, the UE 120 may generally predict, estimate, or otherwise determine an uplink traffic pattern over an upcoming time period according to an output from one or more AI/ML models, a historical uplink transmission history, and/or a future uplink traffic pattern, which the UE 120 may use to determine one or more slots, symbols, or other intervals in which support for uplink communication may be needed (e.g., in an uplink-only half-duplexing mode, an uplink sub-band in an SBFD mode, or in uplink frequency resources that otherwise support full-duplex communication, such as in a partially overlapping or fully overlapping IBFD mode). Furthermore, the UE 120 may predict, estimate, or otherwise determine a downlink traffic pattern over the upcoming time period according to an output from one or more AI/ML models, a historical uplink transmission history, and/or a future uplink traffic pattern (e.g., based on the actual or predicted downlink traffic buffer status indicated by the network node 110), which the UE 120 may then use to determine one or more slots, symbols, or other intervals in which support for simultaneous uplink and downlink communication is needed (e.g., in an SBFD mode, a partially overlapping or fully overlapping IBFD mode, or another suitable full-duplex communication mode).

As further shown in FIG. 8, and by reference number 840, the UE 120 may transmit, and the network node 110 may receive, signaling to initiate a time window with support for uplink communication or support for simultaneous uplink and downlink communication in each interval within the time window based on the expected uplink traffic pattern and the expected downlink traffic pattern during the time window. For example, in cases where the UE 120 predicts an uplink-heavy traffic pattern during the time window, the signaling transmitted by the UE 120 may include a request for a duplexing configuration that includes an uplink transmission opportunity in each interval within the time window, such that the UE 120 can perform an uplink transmission in each interval within the time window. For example, in some aspects, the UE 120 may request that the network node 110 switch from a current duplexing mode in which the network node 110 operates in an SBFD or full-duplexing mode and the UE 120 operates in a half-duplexing mode, to a duplexing mode in which the UE 120 operates in an SBFD or full-duplexing mode (e.g., such that the UE can receive on a downlink and transmit on an uplink in each interval within the time window).

Additionally, or alternatively, the UE 120 may request that the network node 110 switch from a current duplexing mode in which the network node 110 and/or the UE 120 are operating in an SBFD mode (e.g., according to a D+U+D SBFD pattern, a D+U pattern, or an F+U+F pattern) or a full-duplexing mode, to a legacy uplink-only half-duplexing mode or an SBFD mode in which each sub-band is configured as an uplink sub-band. Additionally, or alternatively, the UE 120 may request that the network node 110 switch from a current duplexing mode in which the network node 110 and the UE 120 are operating in a legacy downlink-only half-duplexing mode, to a duplexing mode in which the network node 110 and/or the UE 120 communicate in an SBFD mode or another full-duplexing mode. Additionally, or alternatively, the UE 120 may request that the network node 110 switch from a current duplexing mode in which each interval is configured in a legacy flexible mode (e.g., configurable as uplink or downlink), to a duplexing mode in which each interval is a legacy uplink-only interval or an SBFD or full-duplexing interval for the network node 110 and/or the UE 120. In this way, when the UE 120 predicts an uplink-heavy traffic pattern, the UE 120 can request or initiate a time window that includes an uplink transmission opportunity in each interval.

Additionally, or alternatively, in cases where the UE 120 predicts an uplink-heavy and downlink-heavy traffic pattern during the time window, the signaling transmitted by the UE 120 may include a request for a duplexing configuration that includes uplink transmission and downlink transmission opportunities in each interval within the time window, such that the UE 120 can perform an uplink transmission and receive a downlink communication in each interval within the time window. For example, in some aspects, the UE 120 may request that the network node 110 switch from a current duplexing mode in which the network node 110 is operating in an SBFD or full-duplexing mode and the UE 120 is operating in a half-duplexing mode, to a duplexing mode in which the UE 120 operates in an SBFD or full-duplexing mode (e.g., such that the UE can receive on a downlink and transmit on an uplink in each interval within the time window). Additionally, or alternatively, the UE 120 may request that the network node 110 switch from a current duplexing configuration in which each interval is an uplink-only, downlink-only, or flexible interval, to a duplexing configuration in which the UE 120 operates in an SBFD or full-duplexing mode. In this way, when the UE 120 predicts an uplink-heavy and downlink-heavy traffic pattern, the UE 120 can request or initiate a time window that includes support for SBFD or full-duplex (e.g., partially or overlapping IBFD) communication in each interval.

In some aspects, as described herein, the time window that is requested or initiated by the UE 120 may be a periodic time window that repeats according to a given periodicity, or the time window may be a one-time aperiodic time window that does not repeat. Additionally, or alternatively, the time window that is requested or initiated by the UE 120 may be a periodic pattern that includes multiple windows with variable lengths and/or variable inter-window intervals in each cycle. Furthermore, for each time window that the UE 120 requests or initiates, the UE 120 may indicate a starting interval (e.g., an index associated with a starting slot or a starting symbol) and a length of the time window, or the UE 120 may indicate the starting interval and an ending interval (e.g., an index associated with an ending slot or an ending symbol). Additionally, or alternatively, a set of half-duplexing and full-duplexing communication patterns may be defined (e.g., in a wireless communication standard or configured by RRC or other suitable signaling), and the UE 120 can indicate an index associated with the duplexing configuration that the UE 120 is requesting for the time window.

As further shown in FIG. 8, and by reference number 850, the network node 110 may transmit, and the UE 120 may receive, signaling that indicates a duplexing configuration during the time window. For example, the duplexing configuration indicated by the network node 110 may correspond to the duplexing configuration requested or initiated by the UE 120, may modify the duplexing configuration requested or initiated by the UE 120, and/or may be independent from the duplexing configuration requested or initiated by the UE 120 (e.g., depending on self-interference conditions at the network node 110 and/or the UE 120, traffic demands associated with other UEs, or other suitable conditions).

As further shown in FIG. 8, and by reference number 860, the UE 120 may transmit, and the network node 110 may receive, one or more uplink communications during the time window in accordance with the duplexing configuration indicated by the network node 110. For example, in cases where the UE 120 predicts an uplink-heavy traffic pattern and signals a request to initiate a time window in which each interval supports uplink communication, the network node 110 may switch to a duplexing configuration in which each interval supports uplink communication, or to a duplexing configuration that includes more uplink transmission opportunities than a current duplexing configuration. Accordingly, the UE 120 may use the additional uplink transmission opportunities to accommodate the uplink-heavy traffic pattern. In some aspects, as further shown by reference number 860, the network node 110 may transmit, and the UE 120 may receive, one or more downlink communications during the time window in accordance with the duplexing configuration indicated by the network node 110. For example, in cases where the UE 120 predicts an uplink-heavy and downlink-heavy traffic pattern and signals a request to initiate a time window in which each interval supports SBFD or full-duplex communication, the network node 110 may switch to a duplexing configuration in which each interval supports uplink and downlink communication, or to a duplexing configuration that includes more full-duplexing opportunities than a current duplexing configuration. Accordingly, the UE 120 may use the additional downlink reception opportunities to accommodate the downlink-heavy traffic pattern.

As indicated above, FIG. 8 is provided as an example. Other examples may differ from what is described with respect to FIG. 8.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with a UE-initiated duplexing configuration.

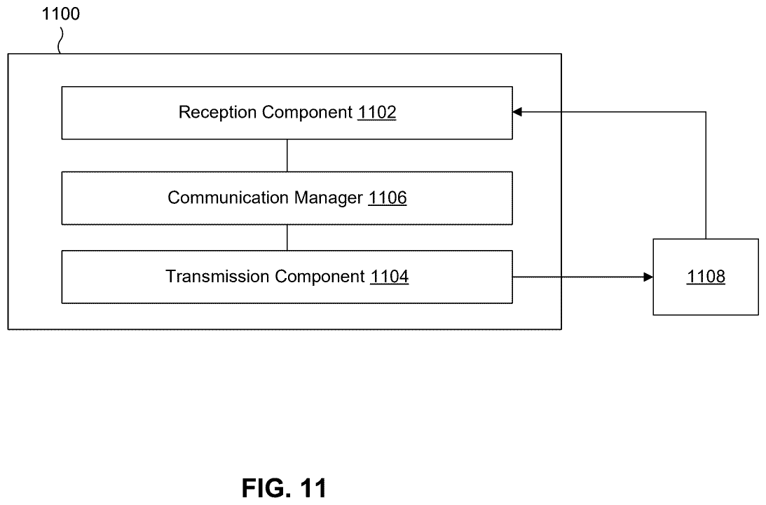

As shown in FIG. 9, in some aspects, process 900 may include transmitting, to a network node, signaling to initiate a time window with support for uplink communication in each interval within the time window based on a predicted uplink traffic pattern during the time window (block 910). For example, the UE (e.g., using transmission component 1104 and/or communication manager 1106, depicted in FIG. 11) may transmit, to a network node, signaling to initiate a time window with support for uplink communication in each interval within the time window based on a predicted uplink traffic pattern during the time window, as described above.

As further shown in FIG. 9, in some aspects, process 900 may include receiving, from the network node, signaling that indicates a duplexing configuration during the time window (block 920). For example, the UE (e.g., using reception component 1102 and/or communication manager 1106, depicted in FIG. 11) may receive, from the network node, signaling that indicates a duplexing configuration during the time window, as described above.

As further shown in FIG. 9, in some aspects, process 900 may include transmitting, to the network node, one or more uplink communications during the time window in accordance with the duplexing configuration (block 930). For example, the UE (e.g., using transmission component 1104 and/or communication manager 1106, depicted in FIG. 11) may transmit, to the network node, one or more uplink communications during the time window in accordance with the duplexing configuration, as described above.

Process 900 may include additional aspects, such as any single aspect or any combination of aspects described below and/or in connection with one or more other processes described elsewhere herein.

In a first aspect, the signaling includes a request to switch to a UE SBFD, partially overlapping full-duplexing, or fully overlapping full-duplexing mode for each interval within the time window.

In a second aspect, alone or in combination with the first aspect, the signaling includes a request to switch to an uplink-only half-duplexing mode for each interval within the time window.

In a third aspect, alone or in combination with one or more of the first and second aspects, the signaling includes a request to switch to a network node SBFD, partially overlapping full-duplexing, or fully overlapping full-duplexing mode for each interval within the time window.

In a fourth aspect, alone or in combination with one or more of the first through third aspects, process 900 includes determining the predicted uplink traffic pattern during the time window according to one or more of an output from an AI or ML model, a historical traffic pattern, or a future traffic pattern.

In a fifth aspect, alone or in combination with one or more of the first through fourth aspects, the signaling is further to initiate the time window with support for downlink communication in each interval within the time window based on an estimated downlink traffic pattern during the time window.

In a sixth aspect, alone or in combination with one or more of the first through fifth aspects, process 900 includes receiving, from the network node, one or more downlink communications during the time window in accordance with the duplexing configuration.

In a seventh aspect, alone or in combination with one or more of the first through sixth aspects, the signaling includes a request to switch to a UE SBFD, partially overlapping full-duplexing, or fully overlapping full-duplexing mode for each interval within the time window.

In an eighth aspect, alone or in combination with one or more of the first through seventh aspects, process 900 includes receiving, from the network node, signaling that indicates the estimated downlink traffic pattern during the time window.

In a ninth aspect, alone or in combination with one or more of the first through eighth aspects, process 900 includes predicting the estimated downlink traffic pattern during the time window according to a downlink reception history.

In a tenth aspect, alone or in combination with one or more of the first through ninth aspects, the time window is periodic.

In an eleventh aspect, alone or in combination with one or more of the first through tenth aspects, the time window is aperiodic.

In a twelfth aspect, alone or in combination with one or more of the first through eleventh aspects, the time window is associated with a periodic pattern that includes multiple time windows associated with one or more of a variable length or a variable inter-window interval in each cycle.

In a thirteenth aspect, alone or in combination with one or more of the first through twelfth aspects, the signaling indicates the time window according to an index associated with a starting interval and one or more of a length or an index associated with an ending interval.

In a fourteenth aspect, alone or in combination with one or more of the first through thirteenth aspects, the signaling indicates the time window according to an index associated with a half-duplexing or full-duplexing pattern.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with a UE-initiated duplexing configuration.

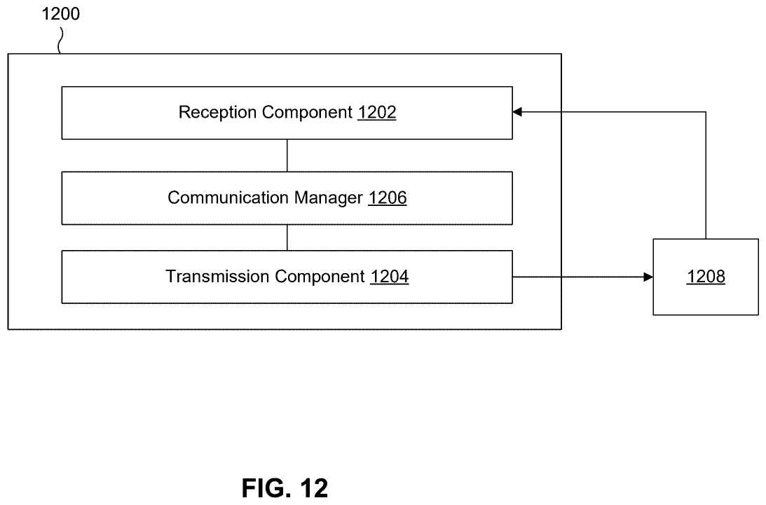

As shown in FIG. 10, in some aspects, process 1000 may include receiving, from a UE, signaling to initiate a time window with support for uplink communication in each interval within the time window based on a predicted uplink traffic pattern during the time window (block 1010). For example, the network node (e.g., using reception component 1202 and/or communication manager 1206, depicted in FIG. 12) may receive, from a UE, signaling to initiate a time window with support for uplink communication in each interval within the time window based on a predicted uplink traffic pattern during the time window, as described above.

As further shown in FIG. 10, in some aspects, process 1000 may include transmitting, to the UE, signaling that indicates a duplexing configuration during the time window (block 1020). For example, the network node (e.g., using transmission component 1204 and/or communication manager 1206, depicted in FIG. 12) may transmit, to the UE, signaling that indicates a duplexing configuration during the time window, as described above.

As further shown in FIG. 10, in some aspects, process 1000 may include receiving, from the UE, one or more uplink communications during the time window in accordance with the duplexing configuration (block 1030). For example, the network node (e.g., using reception component 1202 and/or communication manager 1206, depicted in FIG. 12) may receive, from the UE, one or more uplink communications during the time window in accordance with the duplexing configuration, as described above.

Process 1000 may include additional aspects, such as any single aspect or any combination of aspects described below and/or in connection with one or more other processes described elsewhere herein.

In a first aspect, the signaling includes a request to switch to a UE SBFD, partially overlapping full-duplexing, or fully overlapping full-duplexing mode for each interval within the time window.

In a second aspect, alone or in combination with the first aspect, the signaling includes a request to switch to an uplink-only half-duplexing mode for each interval within the time window.

In a third aspect, alone or in combination with one or more of the first and second aspects, the signaling includes a request to switch to a network node SBFD, partially overlapping full-duplexing, or fully overlapping full-duplexing mode for each interval within the time window.

In a fourth aspect, alone or in combination with one or more of the first through third aspects, the signaling is further to initiate the time window with support for downlink communication in each interval within the time window based on an estimated downlink traffic pattern during the time window.

In a fifth aspect, alone or in combination with one or more of the first through fourth aspects, process 1000 includes transmitting, to the UE, one or more downlink communications during the time window in accordance with the duplexing configuration.

In a sixth aspect, alone or in combination with one or more of the first through fifth aspects, the signaling includes a request to switch to a UE SBFD, partially overlapping full-duplexing, or fully overlapping full-duplexing mode for each interval within the time window.

In a seventh aspect, alone or in combination with one or more of the first through sixth aspects, process 1000 includes transmitting, to the UE, signaling that indicates the estimated downlink traffic pattern during the time window.

In an eighth aspect, alone or in combination with one or more of the first through seventh aspects, the time window is periodic.

In a ninth aspect, alone or in combination with one or more of the first through eighth aspects, the time window is aperiodic.

In a tenth aspect, alone or in combination with one or more of the first through ninth aspects, the time window is associated with a periodic pattern that includes multiple time windows associated with one or more of a variable length or a variable inter-window interval in each cycle.

In an eleventh aspect, alone or in combination with one or more of the first through tenth aspects, the signaling indicates the time window according to an index associated with a starting interval and one or more of a length or an index associated with an ending interval.

In a twelfth aspect, alone or in combination with one or more of the first through eleventh aspects, the signaling indicates the time window according to an index associated with a half-duplexing or full-duplexing pattern.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 8-9. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit, to a network node, signaling to initiate a time window with support for uplink communication in each interval within the time window based on a predicted uplink traffic pattern during the time window. The reception component 1102 may receive, from the network node, signaling that indicates a duplexing configuration during the time window. The transmission component 1104 may transmit, to the network node, one or more uplink communications during the time window in accordance with the duplexing configuration.

The communication manager 1106 may determine the predicted uplink traffic pattern during the time window according to one or more of an output from an AI or ML model, a historical traffic pattern, or a future traffic pattern.

The reception component 1102 may receive, from the network node, one or more downlink communications during the time window in accordance with the duplexing configuration.

The reception component 1102 may receive, from the network node, signaling that indicates the estimated downlink traffic pattern during the time window.

The communication manager 1106 may predict the estimated downlink traffic pattern during the time window according to a downlink reception history.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 8-9. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive, from a UE, signaling to initiate a time window with support for uplink communication in each interval within the time window based on a predicted uplink traffic pattern during the time window. The transmission component 1204 may transmit, to the UE, signaling that indicates a duplexing configuration during the time window. The reception component 1202 may receive, from the UE, one or more uplink communications during the time window in accordance with the duplexing configuration.

The transmission component 1204 may transmit, to the UE, one or more downlink communications during the time window in accordance with the duplexing configuration.

The transmission component 1204 may transmit, to the UE, signaling that indicates the estimated downlink traffic pattern during the time window.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a UE, comprising: transmitting, to a network node, signaling to initiate a time window with support for uplink communication in each interval within the time window based on a predicted uplink traffic pattern during the time window; receiving, from the network node, signaling that indicates a duplexing configuration during the time window; and transmitting, to the network node, one or more uplink communications during the time window in accordance with the duplexing configuration.

Aspect 2: The method of Aspect 1, wherein the signaling includes a request to switch to a UE SBFD, partially overlapping full-duplexing, or fully overlapping full-duplexing mode for each interval within the time window.

Aspect 3: The method of any of Aspects 1-2, wherein the signaling includes a request to switch to an uplink-only half-duplexing mode for each interval within the time window.

Aspect 4: The method of any of Aspects 1-3, wherein the signaling includes a request to switch to a network node SBFD, partially overlapping full-duplexing, or fully overlapping full-duplexing mode for each interval within the time window.

Aspect 5: The method of any of Aspects 1-4, further comprising: determining the predicted uplink traffic pattern during the time window according to one or more of an output from an AI or ML model, a historical traffic pattern, or a future traffic pattern.

Aspect 6: The method of any of Aspects 1-5, wherein the signaling is further to initiate the time window with support for downlink communication in each interval within the time window based on an estimated downlink traffic pattern during the time window.

Aspect 7: The method of Aspect 6, further comprising: receiving, from the network node, one or more downlink communications during the time window in accordance with the duplexing configuration.

Aspect 8: The method of Aspect 6, wherein the signaling includes a request to switch to a UE SBFD, partially overlapping full-duplexing, or fully overlapping full-duplexing mode for each interval within the time window.

Aspect 9: The method of Aspect 6, further comprising: receiving, from the network node, signaling that indicates the estimated downlink traffic pattern during the time window.

Aspect 10: The method of Aspect 6, further comprising: predicting the estimated downlink traffic pattern during the time window according to a downlink reception history.

Aspect 11: The method of any of Aspects 1-10, wherein the time window is periodic.

Aspect 12: The method of any of Aspects 1-11, wherein the time window is aperiodic.

Aspect 13: The method of any of Aspects 1-12, wherein the time window is associated with a periodic pattern that includes multiple time windows associated with one or more of a variable length or a variable inter-window interval in each cycle.

Aspect 14: The method of any of Aspects 1-13, wherein the signaling indicates the time window according to an index associated with a starting interval and one or more of a length or an index associated with an ending interval.

Aspect 15: The method of any of Aspects 1-14, wherein the signaling indicates the time window according to an index associated with a half-duplexing or full-duplexing pattern.

Aspect 16: A method of wireless communication performed by a network node, comprising: receiving, from a user equipment (UE), signaling to initiate a time window with support for uplink communication in each interval within the time window based on a predicted uplink traffic pattern during the time window; transmitting, to the UE, signaling that indicates a duplexing configuration during the time window; and receiving, from the UE, one or more uplink communications during the time window in accordance with the duplexing configuration.

Aspect 17: The method of Aspect 16, wherein the signaling includes a request to switch to a UE SBFD, partially overlapping full-duplexing, or fully overlapping full-duplexing mode for each interval within the time window.

Aspect 18: The method of any of Aspects 16-17, wherein the signaling includes a request to switch to an uplink-only half-duplexing mode for each interval within the time window.

Aspect 19: The method of any of Aspects 16-18, wherein the signaling includes a request to switch to a network node SBFD, partially overlapping full-duplexing, or fully overlapping full-duplexing mode for each interval within the time window.

Aspect 20: The method of any of Aspects 16-19, wherein the signaling is further to initiate the time window with support for downlink communication in each interval within the time window based on an estimated downlink traffic pattern during the time window.

Aspect 21: The method of Aspect 20, further comprising: transmitting, to the UE, one or more downlink communications during the time window in accordance with the duplexing configuration.

Aspect 22: The method of Aspect 20, wherein the signaling includes a request to switch to a UE SBFD, partially overlapping full-duplexing, or fully overlapping full-duplexing mode for each interval within the time window.

Aspect 23: The method of Aspect 20, further comprising: transmitting, to the UE, signaling that indicates the estimated downlink traffic pattern during the time window.

Aspect 24: The method of any of Aspects 16-23, wherein the time window is periodic.

Aspect 25: The method of any of Aspects 16-24, wherein the time window is aperiodic.

Aspect 26: The method of any of Aspects 16-25, wherein the time window is associated with a periodic pattern that includes multiple time windows associated with one or more of a variable length or a variable inter-window interval in each cycle.

Aspect 27: The method of any of Aspects 16-26, wherein the signaling indicates the time window according to an index associated with a starting interval and one or more of a length or an index associated with an ending interval.

Aspect 28: The method of any of Aspects 16-27, wherein the signaling indicates the time window according to an index associated with a half-duplexing or full-duplexing pattern.

Aspect 29: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-28.

Aspect 30: An apparatus for wireless communication at a device, the apparatus comprising one or more memories and one or more processors coupled to the one or more memories, the one or more processors configured to cause the device to perform the method of one or more of Aspects 1-28.

Aspect 31: An apparatus for wireless communication, the apparatus comprising at least one means for performing the method of one or more of Aspects 1-28.

Aspect 32: A non-transitory computer-readable medium storing code for wireless communication, the code comprising instructions executable by one or more processors to perform the method of one or more of Aspects 1-28.

Aspect 33: A non-transitory computer-readable medium storing a set of instructions for wireless communication, the set of instructions comprising one or more instructions that, when executed by one or more processors of a device, cause the device to perform the method of one or more of Aspects 1-28.

Aspect 34: A device for wireless communication, the device comprising a processing system that includes one or more processors and one or more memories coupled with the one or more processors, the processing system configured to cause the device to perform the method of one or more of Aspects 1-28.

Aspect 35: An apparatus for wireless communication at a device, the apparatus comprising one or more memories and one or more processors coupled to the one or more memories, the one or more processors individually or collectively configured to cause the device to perform the method of one or more of Aspects 1-28.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A method of wireless communication performed by a user equipment (UE), comprising:
transmitting, to a network node, signaling to initiate a time window with support for uplink communication in each interval within the time window based on a predicted uplink traffic pattern during the time window;
receiving, from the network node, signaling that indicates a duplexing configuration during the time window; and
transmitting, to the network node, one or more uplink communications during the time window in accordance with the duplexing configuration.

2. The method of claim 1, wherein the signaling includes a request to switch to a UE sub-band full-duplexing, partially overlapping full-duplexing, or fully overlapping full-duplexing mode for each interval within the time window.

3. The method of claim 1, wherein the signaling includes a request to switch to an uplink-only half-duplexing mode for each interval within the time window.

4. The method of claim 1, wherein the signaling includes a request to switch to a network node sub-band full-duplexing, partially overlapping full-duplexing, or fully overlapping full-duplexing mode for each interval within the time window.

5. The method of claim 1, further comprising:
determining the predicted uplink traffic pattern during the time window according to one or more of an output from an artificial intelligence or machine learning model, a historical traffic pattern, or a future traffic pattern.

6. The method of claim 1, wherein the signaling is further to initiate the time window with support for downlink communication in each interval within the time window based on an estimated downlink traffic pattern during the time window.

7. The method of claim 6, further comprising:
receiving, from the network node, one or more downlink communications during the time window in accordance with the duplexing configuration.

8. The method of claim 6, wherein the signaling includes a request to switch to a UE sub-band full-duplexing, partially overlapping full-duplexing, or fully overlapping full-duplexing mode for each interval within the time window.

9. The method of claim 6, further comprising:
receiving, from the network node, signaling that indicates the estimated downlink traffic pattern during the time window.

10. The method of claim 6, further comprising:
predicting the estimated downlink traffic pattern during the time window according to a downlink reception history.

11. The method of claim 1, wherein the time window is periodic.

12. The method of claim 1, wherein the time window is aperiodic.

13. The method of claim 1, wherein the time window is associated with a periodic pattern that includes multiple time windows associated with one or more of a variable length or a variable inter-window interval in each cycle.

14. The method of claim 1, wherein the signaling indicates the time window according to an index associated with a starting interval and one or more of a length or an index associated with an ending interval.

15. The method of claim 1, wherein the signaling indicates the time window according to an index associated with a half-duplexing or full-duplexing pattern.

16. A method of wireless communication performed by a network node, comprising:
receiving, from a user equipment (UE), signaling to initiate a time window with support for uplink communication in each interval within the time window based on a predicted uplink traffic pattern during the time window;
transmitting, to the UE, signaling that indicates a duplexing configuration during the time window; and
receiving, from the UE, one or more uplink communications during the time window in accordance with the duplexing configuration.

17. The method of claim 16, wherein the signaling includes a request to switch to a UE sub-band full-duplexing, partially overlapping full-duplexing, or fully overlapping full-duplexing mode for each interval within the time window.

18. The method of claim 16, wherein the signaling includes a request to switch to an uplink-only half-duplexing mode for each interval within the time window.

19. The method of claim 16, wherein the signaling includes a request to switch to a network node sub-band full-duplexing, partially overlapping full-duplexing, or fully overlapping full-duplexing mode for each interval within the time window.

20. The method of claim 16, wherein the signaling is further to initiate the time window with support for downlink communication in each interval within the time window based on an estimated downlink traffic pattern during the time window.

21. The method of claim 20, further comprising:
transmitting, to the UE, one or more downlink communications during the time window in accordance with the duplexing configuration.

22. The method of claim 20, wherein the signaling includes a request to switch to a UE sub-band full-duplexing, partially overlapping full-duplexing, or fully overlapping full-duplexing mode for each interval within the time window.

23. The method of claim 20, further comprising:
transmitting, to the UE, signaling that indicates the estimated downlink traffic pattern during the time window.

24. The method of claim 16, wherein the time window is periodic.

25. The method of claim 16, wherein the time window is aperiodic.

26. The method of claim 16, wherein the time window is associated with a periodic pattern that includes multiple time windows associated with one or more of a variable length or a variable inter-window interval in each cycle.

27. The method of claim 16, wherein the signaling indicates the time window according to an index associated with a starting interval and one or more of a length or an index associated with an ending interval.

28. The method of claim 16, wherein the signaling indicates the time window according to an index associated with a half-duplexing or full-duplexing pattern.

29. A user equipment (UE) for wireless communication, comprising:
one or more memories; and
one or more processors, coupled to the one or more memories, configured to cause the UE to:
transmit, to a network node, signaling to initiate a time window with support for uplink communication in each interval within the time window based on a predicted uplink traffic pattern during the time window;
receive, from the network node, signaling that indicates a duplexing configuration during the time window; and
transmit, to the network node, one or more uplink communications during the time window in accordance with the duplexing configuration.

30. A network node for wireless communication, comprising:
one or more memories; and
one or more processors, coupled to the one or more memories, configured to cause the network node to:
receive, from a user equipment (UE), signaling to initiate a time window with support for uplink communication in each interval within the time window based on a predicted uplink traffic pattern during the time window;
transmit, to the UE, signaling that indicates a duplexing configuration during the time window; and
receive, from the UE, one or more uplink communications during the time window in accordance with the duplexing configuration.
